(19) United States
(12) Patent Application Publication
(10) Pub. No.: US 2008/0244670 A1
(43) Pub. Date: Oct. 2, 2008

(54) System and Method for IPTV Service Prompting

(75) Inventor: Zhongxi Huang, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (JP)

(21) Appl. No.: 12/134,616

(22) Filed: Jun. 6, 2008

Related U.S. Application Data
(63) Continuation of application No. PCT/CN2006/003317, filed on Dec. 6, 2006.

(30) Foreign Application Priority Data
Dec. 6, 2005 (CN) 200510127458.4

(51) Int. Cl. H04N 7/16

(52) U.S. Cl. 725/109

(57) ABSTRACT

The embodiment of the present invention discloses a system for IPTV service promoting. And the system includes: a first subsystem, for storing program information of each user; a second subsystem, for determining the program information needed to be prompted according to the program information stored in the first subsystem. The embodiment of the present invention also discloses a method for IPTV service promoting. According to the embodiment of the present invention, the user is timely prompted to get the IPTV program.

### CROSS-REFERENCE TO RELATED APPLICATIONS

This application is a continuation of International Application No. PCT/CN2006/003317, filed Dec. 6, 2006. This application claims the benefit of Chinese Application No. 200510127458.4 filed Dec. 6, 2005. The disclosures of the above applications are incorporated herein by reference.

### FIELD

The present invention relates to Internet Protocol Television (IPTV) service techniques, and more particularly, to a system and method for IPTV service prompting.

### BACKGROUND

The statements in this section merely provide background information related to the present disclosure and may not constitute prior art.

Along with development of broadband network, stream media, coding/decoding, information encryption and memory technology, video service based on Transmission Control Protocol/Internet Protocol (TCP/IP) is implemented in commercial application. In industry, the video service based on IP and its relevant techniques, which are different from service based on Digital Video Broadcast (DVB), are named as IPTV (Internet Protocol Television) service.

An IPTV service system includes: an IPTV client and an IPTV server. Accordingly, the IPTV server, as a living broadcast TV source, provides the IPTV client with IPTV programs though a variety of channels. A web living broadcast software is installed on the IPTV client. The web living broadcast software is used for broadcasting movies and TV programs on network, and getting connected to an IPTV program sources in the IPTV server, and acquiring IPTV program data of certain channel for broadcasting. When a user uses the IPTV service, the user usually needs to browse program parade information several hours or days in advance, and watch the IPTV program via the web living broadcast software installed on the IPTV client when the IPTV program is broadcasted on the network.

However, in general, the user does not keep the web living broadcast software at work state during the whole day. Therefore, the user often forgets program airtime, and can not timely watch the IPTV program needed.

### SUMMARY

Embodiment of the present invention provides a system for IPTV service prompting, and the system includes:

a first subsystem, for storing program information of each user;

a second subsystem, for determining the program information needed to be prompted according to the program information stored in the first subsystem.

The embodiment of the present invention also discloses a method for IPTV service prompting between system for IPTV service prompting and user client, and the method includes the following processes of:

searching, by a system for IPTV service prompting, program information of each user stored in the system for IPTV service prompting, and determining the program information needed to be prompted according to the program information searched, and outputting the program information needed to be prompted to a user client corresponding to a user of the program information needed to be prompted;

displaying, by the user client, the program information needed to be prompted or paying, by the user client, an IPTV program corresponding to the program information needed to be prompted.

Therefore, according to the system and method for IPTV prompting provided by the embodiment of the present invention, the program information needed by user can be dynamically maintained, the program information needed to be prompted can be automatically determined. So the IPTV client can timely prompt the user to watch the program, which greatly facilitates the use of the IPTV service.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating configuration of a system in an embodiment of the present invention.

FIG. 2 is a schematic diagram illustrating processing procedure of a method in another embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

An embodiment of the present invention provides a system for IPTV service prompting. The system for IPTV service prompting includes a program information subsystem and a program prompting subsystem. The program information subsystem is configured to store program information of each user, and configured to output the program information of each user to the program prompting subsystem. The program prompting subsystem is configured to determine the program information needed to be prompted according to the program information from the program information subsystem, and configured to send the program information needed to be prompted to a user client. Thus, the user is timely prompted by the user client to review the program information, or the user client directly runs a web living broadcast software to play an IPTV program according to the program information needed to be prompted. The system and the method of present invention are usually based on Internet technology, and in the embodiments of the present invention, the system and the method of present invention are implemented in the World Wide Web.

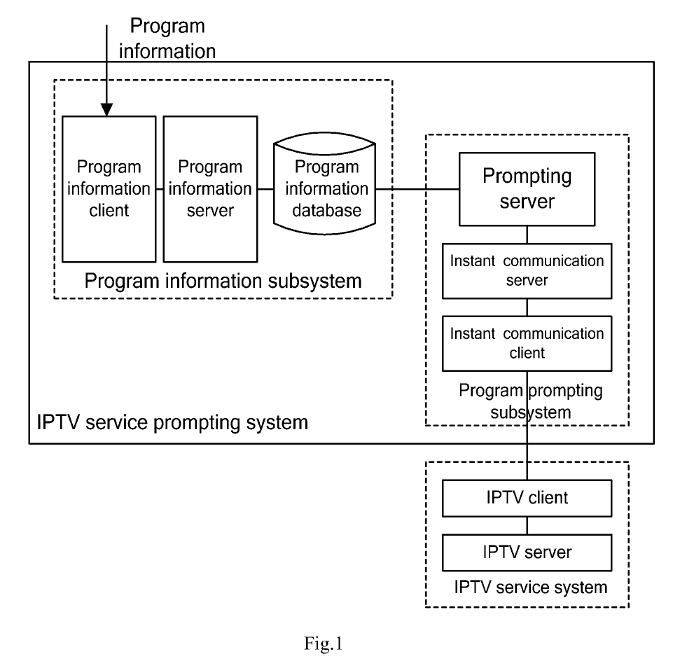

FIG. 1 is a schematic diagram illustrating configuration of a system in an embodiment of the present invention. As shown in FIG. 1, a system for IPTV service prompting is connected with an IPTV client in an IPTV service system. The system for IPTV service prompting includes a program information subsystem and a program prompting subsystem. The program information subsystem statically stores a great deal of program information of users, and the program information subsystem only includes a program information database. Alternatively the program information subsystem can dynamically maintain program information of each user; each user can change its own program information at any moment; and the program information subsystem can also further receive, from the outside, and keep the program information of users. In the above situation, the program information subsystem includes a program information client, a program information server and a program information database. And the program prompting subsystem includes a prompting server, an information notification client and an information notification server.

In the above mentioned system, the program information client is configured to receive, from the outside, and send the program information of user to the program information server. And the program information client can receive, from the outside, program parade information. The program information client can further output and display the program parade information to the user, when a user requests the program parade information. The user obtains the program parade information by, for example, browsing WEB pages. And the user selects the program information needed by the user and inputs the program information needed by the user to the program information client. The program information server is configured to receive the program information of user from the program information client, and input the program information of user to the program information database for storage. The program information database is configured to store the program information of each user, receive a query request from a prompting server, and output the program information to the prompting server. The prompting server is configured to periodically search program information in the program information database via the query request, determine whether the program information needs to be prompted, determine the program information needed to be prompted at present, extract all the program information needed to be prompted from the program information database, and output the program information needed to be prompted to the information notification server. The information notification server is configured to receive, from the prompting server, and output the program information to the information notification client corresponding to user of the program information. The information notification client is configured to receive the program information from the information notification server, and output the program information received to the user client corresponding to the user of the program information. And the user client displays the program information to the user; or the user client runs a web living broadcast software and plays the corresponding IPTV program according to the program information. In this embodiment, the information notification server can be connected with at least one information notification client, each information notification client can correspond to at least one user, each user client can correspond to at least one user, and each information notification client can be connected with at least one user client. For the users corresponding to the information notification client, the user client corresponding to the user needs to be connected with the information notification client.

In the above mentioned embodiment, the user client may be any one of media playing client which can be used for playing IPTV program (e.g., IPTV client, Windows Media Player, Real Player, or Playing Point of SRTEAM (PPSTREAM)). And the information notification server and the information notification client can be any kind of server and client which can issue notification information according to a user ID. In general, an instant communication server and an instant communication client are taken respectively as the information notification server and the information notification client in this embodiment of the present invention, which ensures the timely prompting for the IPTV program. There is a variety of instant communication servers/clients which are not limited in this embodiment of the present invention.

There have been instant communication service and subscription prompting service in the industry; and the instant communication service allows implementing the instant communication in the Internet and the multiparty group communication via the point-to-point technique; and the subscription prompting service allows periodically sending the prompting message to the user according to the time subscribed by the user. So functions of the prompting server, the instant communication client and the instant communication server as described above can be implemented, and the implementation inside the above mentioned servers will not be described in detail in the following description.

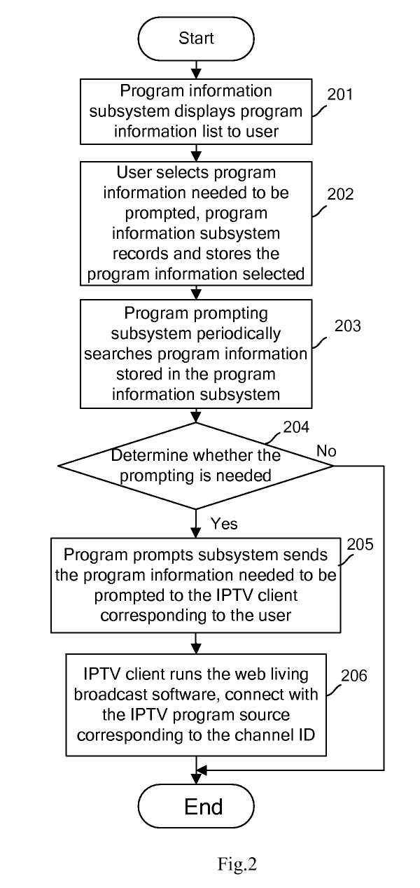

Based on of the above mentioned system, the embodiment of the present invention also provides a method for IPTV service prompting, which is used in the system including the above mentioned system for IPTV service prompting and the user client. And in the embodiment of the present invention the user client is an IPTV client. The process of the method in the embodiment of the present invention and the operational principle of the system in the embodiment of the present invention are hereinafter described in detail with reference to FIG. 2.

FIG. 2 is a schematic diagram illustrating processing procedure of a method in another embodiment of the present invention. As shown in FIG. 2, the process includes steps as follows.

Step 201: a program information client in a program information subsystem displays program parade information usually displayed in a program information list to a user.

Step 202: according to the program parade information displayed at the program information client, the user selects from the program parade information the program information needed to be prompted. The program information client records the program information selected by the user, and sends the program information selected to a program information server, and the program information server sends the received program information selected by the user to a program information database for storage. The program information server can be connected with at least one program information client. And each of the program information client transfers the program information received to the program information server connected with the program information client.

The program information client and the program information server are usually based on Internet technology. For example, in the embodiments of the present invention, the system and the method of present invention are implemented in the World Wide Web. The program information client can, via a WEB system, transfers the program information selected by the user to the program information server at background. For example, the program information client submits the program information to the WEB-based program information server in a POST mode through Hypertext Transfer Protocol (HTTP). The program information server can, via a Common Gateway Interface (CGI) program, obtains the program information submitted by the program information client according to the HTTP. And the program information server, via an Application Interface (API) of the program information database, stores the program information received in a program information database at background which is based on the Structured Query Language (SQL) technique. Here, the program information at least includes one of the following information: user ID, channel ID, airtime, program name (e.g., sports news).

In the above step 201 and step 202, the program information subsystem dynamically maintains the program information of the user. Then the program information subsystem can, at any moment, update the program information recorded in the program information database according to the program information input by the user.

Alternatively, the program information subsystem can statically maintain the program information of each user. In this situation, the program information subsystem can only include one program information database; a system operator pre-saves the program information customized by each user in the program information database, and the step 201 and step 202 can not be performed in this situation.

Step 203: the prompting server in the program prompting system subsystem, in a preset period, searches the program information in the program information database, and performs the following steps 204-206 to the program information searched by the prompting server.

Step 204: determine whether the prompting is needed for the currently program information searched by the prompting server; if so, proceed to step 205; otherwise, terminate the current procedure.

The process of determining whether the prompting is needed for the currently program information searched by the prompting server includes: prompting the server to poll an airtime field in specific program information recorded in the program information database at background, and working out, by comparison and calculation, the time difference between the airtime recorded in the airtime field and the actual time at present, determining whether this time difference is within a preset threshold, for example, 5 minutes; if so, it can be determined that the prompting is needed for the program information; otherwise, the prompting is not yet needed for the program information. And the time of the prompting server can be taken as the actual time at present for the above mentioned calculation; besides, the airtime field of the program information recorded in the program information database can be directly obtained by means of database development interface API, and the database development interface API makes use of SQL statement. The method for field inquiry is not limited by the embodiment of the present invention, but covered in protection scope of the present invention.

Step 205: the program prompting subsystem sends the program information needed to be prompted at present to an IPTV client corresponding to the user of the program information. The program prompting subsystem, after the program information needed to be prompted is determined, can further delete the program information needed to be prompted from the program information database.

The process of sending program information to the IPTV client includes: prompting the server to send the program information needed to be prompted to an instant communication server; determining, by the instant communication server, the instant communication client corresponding to the user of the program information received according to a user ID in the program information received, and sending the program information received to the instant communication client determined; determining, by the instant communication client determined, the IPTV client corresponding to the user of the program information received according to the user ID in the program information received, and sending the program information received to the IPTV client.

The program information transmitted between the prompting server and the instant communication server, and the program information transmitted between the instant communication server and the IPTV client may be based on the Transmission Control Protocol (TCP) or User Datagram Protocol (UDP).

Step 206: upon receipt of the program information, the IPTV client can process in the following two modes: I. displaying the program information for the user, for example, directly displaying the program information on screen of the IPTV client, then the user can be aware of the IPTV program to be played, and the user determine whether to run the web living broadcast software to watch the IPTV program. II. automatically running the web living broadcast software installed on the IPTV client; then the web living broadcast software can, according to a channel ID in the program information, connect with an IPTV program source corresponding to the channel ID on the IPTV server, and acquire IPTV program data from the IPTV program source and plays the IPTV program corresponding to the program information. In this embodiment, the IPTV client can transfer the channel ID to be played to the web living broadcast software by calling a Component Object Model (COM) interface of the web living broadcast software.

The process of connecting by the web living broadcast software to the IPTV program source, and the process of obtaining data from the IPTV program source to be played are not the technical problem be solved in the present invention, and the above mentioned processes can be implemented in the prior art, so no further description is provided here.

The above mentioned embodiment substantially includes the following three processes: I. the process of the program information subsystem dynamically maintaining the program information as described in step 201 and step 202; II. the process of the periodically searching the program information as described in step 203; III. the processes for the program information needed to be prompted as described in steps 204-206. These three processes are independent, so the order of performing the three processes is not limited in the present invention.

To sum up, the use of the system and method of embodiment of the present invention allows timely prompting the user to watch the IPTV program to be played, which greatly facilitates use of the IPTV service. The solution in the embodiment of the present invention is good in implementation without much change in the existing IPTV service system, so that it has considerable commercial value and is worth being implemented.

The foregoing description is only preferred embodiments of the present invention, and is not for use in limiting the protection scope thereof. Any modification, equivalent replacement or improvement made under the spirit and principles of the present invention is included in the protection scope of the claims of the present invention.

What is claimed is:

1. A system for Internet Protocol Television (IPTV), service prompting, comprising:
a first subsystem, for storing program information of each user;
a second subsystem, for determining the program information needed to be prompted according to the program information stored in the first subsystem.

2. The system of claim 1, wherein the first subsystem comprises a program information database.

3. The system of claim 1, wherein the first subsystem comprises:
a first client, for receiving program information of each user;
a first server, for receiving the program information of each user from the program information client;
a first database, for receiving and storing the program information of each user from the first server.

4. The system of claim 3, wherein the first server is connected with at least one first client, each first client receives the program information of at least one user of the first client.

5. The system of claim 1, wherein the second subsystem comprises:
a second server, for searching the first subsystem for the program information, and determining the program information needed to be prompted, obtaining the program information needed to be prompted from the first subsystem, and outputting the program information needed to be prompted;
a third server, for receiving and outputting the program information needed to be prompted from the second server;
a second client, for receiving, from the third server, the program information needed to be prompted, and outputting the program information needed to be prompted to a user client corresponding to the program information needed to be prompted, and wherein each of the second clients outputs the program information needed to be prompted to at least one user client corresponding to the program information needed to be prompted.

6. The system of claim 5, wherein the third server is connected with at least one of the second clients.

7. A method for Internet Protocol Television (IPTV), service prompting between system for IPTV service prompting and user client, comprising:
searching, by a system for IPTV service prompting, program information of each user stored in the system for IPTV service prompting, and determining the program information needed to be prompted according to the program information searched, and outputting the program information needed to be prompted to a user client corresponding to a user of the program information needed to be prompted;
displaying, by the user client, the program information needed to be prompted, or playing, by the user client, an IPTV program corresponding to the program information needed to be prompted.

8. The method of claim 7, further comprising:
outputting, by the system for IPTV program prompting, program parade information to the user;
selecting, by the user, according to the program parade information, the program information, and inputting the program information selected to the system for IPTV service prompting for storage.

9. The method of claim 7, wherein the process of determining the program information needed to be prompted comprises:
calculating a time difference between a playing time contained in the program information searched and a current time; if the time difference is within a preset time threshold, determining that the program information searched needs to be prompted.

10. The method of claim 7, further comprising:
upon determining the program information needed to be prompted, erasing the program information needed to be prompted which is stored in the system for IPTV program prompting.

11. The method of claim 9, further comprising:
upon determining the program information needed to be prompted, erasing the program information needed to be prompted which is stored in the system for IPTV program prompting.

12. The method of claim 7, wherein the process of playing the IPTV program corresponding to program information needed to be prompted comprising:
determining an IPTV program source corresponding to the program information according to a channel ID contained in the program information needed to be prompted; and
connecting with the IPTV program source determined, acquiring IPTV program data corresponding to the program information needed to be prompted, and playing the IPTV program data.

13. The method of claim 7, wherein the process of outputting the program information needed to be prompted to the user client corresponding to the user of the program information needed to be prompted comprises:
determining the user client corresponding to the user of that program information according to the user ID contained in the program information needed to be prompted, and outputting the program information needed to be prompted to the user client determined.
